(19) United States
(12) Patent Application Publication
(10) Pub. No.: US 2007/0029777 A1
(43) Pub. Date: Feb. 8, 2007

(54) Mathematics notebook

(76) Inventor: Patricia McGee Williams, Winston-Salem, NC (US)

Correspondence Address: Charles Y. Lackey, PO Box 5871, Winston-Salem, NC, 27104, US

(21) Appl. No.: 11/177,961

(22) Filed: Jul. 11, 2005

(51) Int. Cl. B42D 1/00

(52) U.S. Cl. 281/21.1

(57) ABSTRACT

A mathematics notebook having specially designed pages each having top and bottom horizontal edges, left and right vertical edges, and top and left side margins. A plurality of vertical lines are positioned on the page to guide the user in placing columns of numbers in vertical alignment to prevent error because of vertical misalignment. A number of pages may be spirally bound together along the page top edges. The vertical lines are positioned each equidistant from adjacent vertical lines, and the pages are spirally bound together along their top horizontal edges. A perforation line is provided near the upper page edge just below the binding material to permit each page to be neatly and smoothly removed from a quantity of additional pages.

### BACKGROUND OF THE INVENTION

1. Field of the Invention

The present invention relates to a mathematics teaching guide and, more particularly, to a mathematics teaching guide in the form of a notebook with a plurality of pages each having a number of pages of vertical lines to guide the user in entering numbers in vertical alignment.

2. Description of the Prior Art

Many training aids have been developed over the years to aid beginning students with the study and mastery of mathematics. Some of these are based on the teaching of longhand writing wherein the correct margins and line spacing are positioned on a base structure and such margins and spacings show through the unmarked writing paper and thereby offer the beginner correct page and line positioning on the previously unmarked paper. These devices can also be of assistance in the teaching of mathematics to keep rows of numbers level and evenly spaced from each other and at appropriate distances from page beginning and ending edges.

When mathematics fundamentals are absorbed and slowly emerge, other troublesome characteristics in the beginner student are sometimes noticed and challenge the teacher to deal effectively with them. For example, some students have great difficulty controlling a writing instrument and correctly forming letters and numbers. With this weakness, size and incorrect spacing and alignment of numbers cause many calculation errors. One such learning difference is referred to as dysgraphia. This problem can be extremely frustrating for the student who, despite his or her writing limitations, may be an academically gifted math student. Such a student knows the math fundamentals but makes consistent errors on class work, homework and tests. When the student attempts to solve multi-digit computation problems on blank or horizontally lined paper, he or she is unable to write the numbers in straight columns. Thus a need has been identified to overcome the deficiency described, and it is to this need that the present invention is directed.

### OBJECTIVES AND SUMMARY OF THE INVENTION

A primary objective of the present invention is the provision of a simple and inexpensive device for facilitating the teaching of arithmetic.

Another objective of the present invention is the provision of a simplified device for facilitating the teaching of numbers including multidigit addition, subtraction, multiplication and division.

Still another objective of the present invention is the provision of a mathematics notebook page designed primarily to assist students with learning differences but are often helpful to students without differences.

Yet still another further objective of the present invention is the provision of a mathematics notebook page having a plurality of vertical lines to help the students to keep straight vertical lines of numbers as they conduct mathematical exercises.

The foregoing and other objectives are obtained by providing a mathematics notebook with specially designed pages, each of which has top and bottom horizontal edges, left and right side vertical edges and a plurality of vertical lines positioned to guide the user in placing columns of numbers in vertical alignment and thereby to prevent error because of vertical misalignment when performing mathematical calculations. There is a one and one-half inch margin along the top and left side of the page. The pages may be spirally bound together along their top horizontal edges. A perforation line is positioned near the upper plate edge of each sheet just below the binding material thus permitting each page to be torn along the perforation line and placed in a conventional ring loose-leaf notebook utilizing holes provided along the left side vertical edge of each page. The vertical lines are preferably positioned each equidistant from adjacent vertical lines.

### BRIEF DESCRIPTION OF THE DRAWING

FIG. 1 is a perspective view of a mathematics notebook having a plurality of especially designed pages for use in solving mathematical problems;

FIG. 2 is a plan view of one page of a mathematics notebook like those held within the notebook shown in FIG. 1; and

FIG. 3 is a plan view of a page of the present invention being used for multidigit addition, subtraction, multiplication and division.

### DETAILED DESCRIPTION OF THE PREFERRED EMBODIMENT

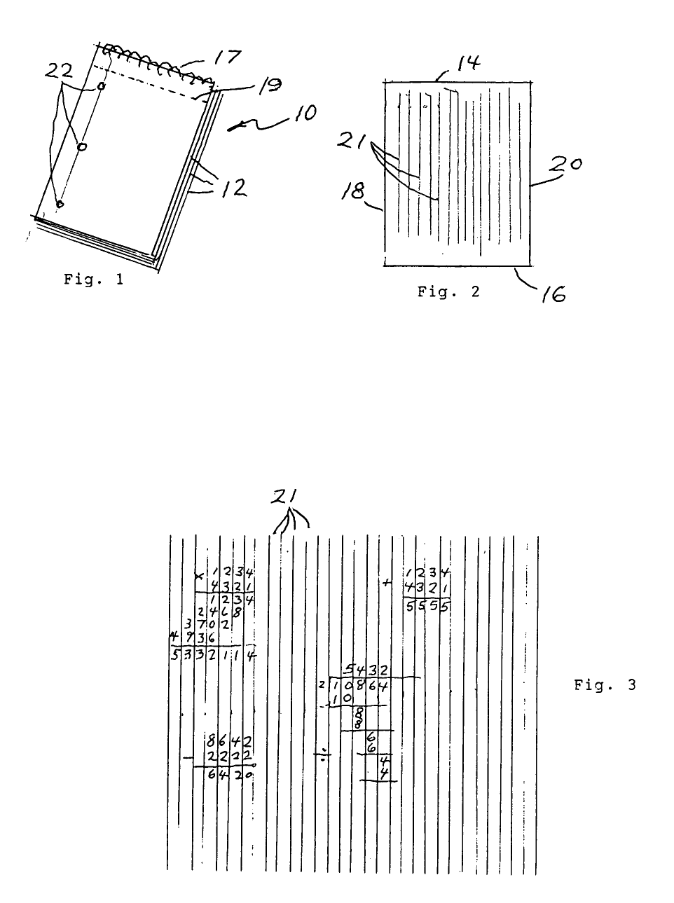

Referring now to the drawings and particularly to FIG. 1, a mathematic notebook shown generally as 10 holds a plurality of pages 12 that are bound together in the notebook formed by positioning a plurality of especially designed pages between two binder covers that are all joined along their top horizontal page edges.

Each page 12 is made up of a sheet of writing paper having top and bottom horizontal edges 14, 16, left and right side vertical edges 18, 20 and a plurality of vertical lines 21. Each page is also provided with top and left side margins 15, 17. Vertical lines 21 are preferably positioned equidistant from each other; i.e., each vertical line being equidistant from adjacent vertical lines 21.

Notebook 10 may be formed as a conventional spiral bound stenographer notebook with the top horizontal edges 14 of each page joined together in the customary manner by a spiral wound binder material 17. Each page 12 is provided with holes 22 along vertical edge 18, a perforation line 19 positioned along horizontal top 14 and just underneath binder material 17 and top and left side margins.

All students who have difficulty writing numbers in columns can be helped by the present invention. The invention also can be helpful by addressing issues such as visual impairment and lack of developmentally adequate fine motor skills. It makes column math work much easier and enables at risk children to achieve better success in school. When provided with the correct tools such as the present invention, they can increase their-esteem and confidence about learning.

From the preceding description, it can be seen that a mathematics notebook has been provided that will meet all the advantages of prior art devices and offer additional advantages not heretofore achievable. With respect to the foregoing invention, the optimum dimensional relationship to the parts of the invention including variations in size, materials, shape, form, function, and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

What is claimed is:

1. A mathematics notebook having a plurality of pages, each page comprising: a sheet of writing paper having top and bottom horizontal edges, a left side vertical edge, and a plurality of vertical lines positioned to guide the user in placing columns of numbers in vertical alignment and thereby preventing error because of vertical misalignment when performing mathematical calculations.

2. The page as claimed in claim 1 wherein the left side of the page has a plurality of holes proximate the left side vertical edge to be compatibly secured within conventional loose leaf notebooks.

3. The page as claimed in claim 1 wherein the sheet has spiral binder perforations proximate the page top horizontal edge.

4. The page as claimed in claim 3 wherein the left side of the page has a plurality of holes proximate the left side vertical edge to be compatibly secured within conventional loose leaf notebooks, the page further comprising top and left side margins.

5. The page as claimed in claim 1 wherein the page vertical lines are positioned each equidistant from adjacent vertical lines.

6. The page as claimed in claim 2 wherein the page vertical lines are positioned each equidistant from adjacent vertical lines.

7. The page as claimed in claim 3 wherein page vertical lines are positioned each equidistant from adjacent vertical lines.

8. The page as claimed in claim 4 wherein page vertical lines are positioned each equidistant from adjacent vertical lines.

9. The page as claimed in claim 1 wherein the page has a perforation line below the top horizontal edge to permit the page to be neatly removed from a quantity of additional pages

10. The page as claimed in claim 2 wherein the page has a perforation line below the top horizontal edge to permit the page to be neatly removed from a quantity of additional pages.

11. The page as claimed in claim 4 wherein the page has a perforation line below the top horizontal edge to permit the page to be neatly removed from a quantity of additional pages.

12. The page as claimed in claim 1 wherein the left side of the page has a plurality of holes proximate the left side vertical edge to be compatibly secured within conventional loose leaf notebooks; the page vertical lines are positioned each equidistant from adjacent vertical lines; and the page has a perforation line below the top horizontal edge to permit the page to be neatly removed from a quantity of additional pages, the page further comprising top and left side margins.
